(19) United States
(12) Patent Application Publication
(10) Pub. No.: US 2021/0197736 A1
(43) Pub. Date: Jul. 1, 2021

(54) Thermally Insulated Structures and Method for Fabricating Same

(71) Applicant: Subzero Insulation and Refrigeration Technologies, Deer Park, NY (US)

(72) Inventor: Gregory J. Iovine, Deer Park, NY (US)

(21) Appl. No.: 17/058,769

(22) PCT Filed: Jun. 7, 2019
(86) PCT No.: PCT/US2019/035982

§ 371 Date: Nov. 25, 2020

Related U.S. Application Data
(60) Provisional application No. 62/682,017, filed on Jun. 7, 2018.

(51) Int. Cl. B60R 13/01; B60R 13/08

(52) U.S. Cl. CPC B60R 13/011; B62D 33/048; B60R 13/08

(57) ABSTRACT

Thermal insulated structures such as walls, ceilings and floors are produced for use in thermo-insulated cargo vans, box trucks, trailers, and other vehicles and compartments. A frame is built a frame in an area, and polyurethane foam insulation is sprayed onto the frame. The polyurethane foam insulation is cut, and then covered with polypropylene panels. The polypropylene panels are secured to the frame, and seams between the polypropylene panels are welded together. Plates are optionally secured to the edges of the panels.

### CROSS-REFERENCE TO RELATED APPLICATION

This application claims priority to U.S. Provisional Application No. 62/682,017, filed on Jun. 7, 2018, which is incorporated by reference in its entirety.

### FIELD

The present disclosure relates to thermally insulated structures and in particular to thermally insulated walls, ceilings, and floors and a method for fabricating the same.

### BACKGROUND

In the prior art, one method for the production of insulating structures is the manual construction of a spray foam liner for insertion into another structure such as the interior of a vehicle. Using the prior art method, a builder frames the inside of a vehicle or compartment using lumber and nails, then sprays closed-cell polyurethane foam insulation throughout the walls, floors and ceiling of the thermo-insulated area. The builder then cuts the polyurethane foam insulation, and covers or encloses the polyurethane foam insulation using panels that are typically cut from medium density fiberboard (MDF) or wood panels composed of other wood products. Once the builder attaches the MDF/wood panels, the seams of the MDF/wood panels are spackled and sanded in order to prepare the MDF/wood panel surfaces. The spackle may be an all purpose joint compound; for example, a sheetrock brand premixed all-purpose drywall joint compound may be used in combination with plaster of Paris.

Then, the builder applies a primer to the exterior of each MDF panel, and, when the primer is ready, the builder typically sprays the primed panels with one or more coats of elastomeric polyurea paint which, when dry, provides a flexible, resilient monolithic membrane with some degree of water and chemical resistance.

The polyurea liner seals any seams that would otherwise allow water or other liquids to seep between the MDF/wood panels and into the insulated walls where any liquid would cause mold and other undesirable conditions.

However, MDF has numerous disadvantages. MDF is an engineered wood product made by breaking down hardwood or softwood residuals into wood fibers, often in a defibrator, combining the wood fibers with wax and a resin binder, and forming panels by applying high temperature and pressure. MDF panels cannot be welded. In addition, MDF has toxic properties. MDF dust, which may be generated during manual or mechanical cutting, drilling, sanding, or other abrading processes and the smoke generated by heating or cutting, may also cause temporary irritation of the eyes and respiratory tract. Allergic skin and lung reactions have been reported with exposure to various wood dusts due to the chemicals present in wood and cured resin. MDF may be formed using formaldehyde, which can cause irritation of skin, eyes, or the respiratory system. As a result, workers must wear respirator equipment when cutting MDF to make panels for installation inside of vehicles.

In another method of the prior art, the installation of prefabricated, thermo-insulated fiberglass panels is performed with the panels designed to fit inside the interior of a specific vehicle or compartment. Pre-fabricated modular kits typically include one or more injected polyurethane foam panels which are custom molded to fit the dimensions and contours of a specific vehicle. The exterior of each panel is typically made from laminated fiberglass. The installer attaches the modular, insulated fiberglass panels to the interior of the thermo-insulated vehicle or compartment. The installer typically fills the seams between each of the pre-fabricated panels with silicone in order to prevent water or other liquids from seeping between or behind the pre-fabricated panels.

The above-described methods of the prior art form and utilize panels which lack durability, flexibility, water-resistance and chemical-resistance, and weldability; that is, the ability to join panels together using a heat-based welding technique.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The purpose of the present invention is to provide a new method to produce thermal insulated walls, ceilings and floors for use in thermo-insulated cargo vans, box trucks, trailers, and other vehicles and compartments. This new method represents an improvement over prior constructions and methods as the properties of the materials used to create the walls are superior for their specific application in terms of durability, flexibility, water-resistance and chemical-resistance, and weldability. This new method also enables the builder to eliminate steps in the production process that is commonly used by those engaged in the production of insulated van, truck and trailer bodies, thereby significantly reducing production time and labor-related costs associated with the production process.

One additional advantage of the present invention includes reduced production time. The present invention serves to eliminate at least five steps in the spray foam liner production process of the prior art. Using polypropylene instead of MDF/wood panels, the present invention allows the builder to eliminate each of the following steps: (i) spackling MDF/wood panels; (ii) sanding MDF/wood panels; (iii) priming MDF/wood panels; (iv) taping or prepping the vehicle for painting; and (v) painting the MDF/wood panels with the elastomeric polyurea paint liner. By eliminating at least these five steps in the production process of the prior art, the builder using the present invention can reduce overall production times by approximately 50% to 75%, depending upon the operation and performance of the steps of the method 10 of the present invention.

Another additional advantage of the present invention includes enhanced material properties. Polypropylene is an ideal material for use in the building of thermo-insulated panels for the following reasons: (i) the durability and flexibility of the materials makes it possible to use a thin sheet of polypropylene with a thickness in the range of about 0.32 cm to about 1.27 cm (about ⅛ inch to about ½ inch) for most applications; (ii) polypropylene maintains its tensile properties even at very low temperatures; and (iii) polypropylene sheets can be welded to create a seamless interior that prevents liquids from reaching the thermo-insulated interior areas.

Another additional advantage of the present invention includes greater water-resistance and chemical-resistance. Polypropylene has a significantly higher degree of water-resistance and chemical-resistance than MDF/wood panels as in the prior art that are sprayed with an elastomeric polyurea paint liner, due to a much greater resistance of polypropylene to tears or punctures that might be caused by pallets, totes or other equipment with sharp edges which are commonly used in the process of loading and unloading temperature-controlled vehicles and compartments.

Another additional advantage of the present invention includes durability, with the ability of welded polypropylene seams to form a much stronger barrier than silicone. Polypropylene panels can be heat-welded together to form a seamless insulated compartment which is easy to clean and therefore extremely useful for the transportation of food items within temperature-controlled, thermo-insulated environments. By contrast, the seams between pre-fabricated modular fiberglass panels as in the prior art are typically filled with silicone which forms a much weaker barrier to water and chemicals and which can degrade over time. In addition, polypropylene sheets provide a much stronger barrier than the laminated fiberglass materials that are typically used in pre-fabricated modular kits in the prior art.

Another additional advantage of the present invention includes versatility and designability/adaptability, in that pre-fabricated modular kits in the prior art are relatively expensive compared to the structures foamed by the present invention, because the dimensions and contours of vehicles and compartments are always changing, requiring modification or customization of the components of the pre-fabricated modular kits in the prior art. With each change to the interior design and dimensions of a vehicle, the pre-fabricated kit manufacturer in the prior art must re-design injection molds for each part in the kit in order to accommodate the altered design and dimensions within each vehicle model. The present invention does not require the use of injection molds; instead, panels are cut from polypropylene sheets and then welded at the seams therebetween. Therefore, the present invention provides enhanced versatility by allowing the user to accommodate vehicle design changes without incurring the higher fixed costs of redesigning and producing new injection molds whenever a vehicle design is altered.

A further advantage of the present invention is that it is lightweight, since the polypropylene used by the present invention is a lightweight thermoplastic polymer. By reducing the overall weight of the insulated panels for the walls, floors, and ceilings installed into a vehicle, there is more payload remaining for other items to be transported within the vehicle. Lower weight also results in better overall vehicle gas mileage as compared to heavier alternatives as in the prior art.

Another additional advantage of the present invention is the insulative properties of polypropylene used by the present invention. Polypropylene, in both its homopolymer and copolymer forms, is a good insulator. In general, plastics are poor heat conductors, because they have virtually no free electrons available for conduction mechanisms as in metals. The thermal insulating capacity of plastics is rated by measuring the thermal conductivity of the plastics. Thermal conduction is the transfer of heat from one part of a body to another with which it is in contact. By reducing thermal conduction, the present invention serves to improve the overall performance of the thermo-insulated walls, floors and ceilings inside a temperature-controlled area. For example, this improved performance can result in reduced cooling times for a refrigerated van with less energy used to power the refrigeration system to achieve the desired temperature and, over the course of time and repetitive usage, reduced wear and tear on the refrigeration system components.

An additional advantage of the present invention is the expansion and contraction of thermoplastic materials used by the present invention. Thermoplastic materials such as polypropylene sheets can expand and contract when exposed to different temperatures. In the present invention, the seams where panels meet are welded using a polypropylene rod that is melted and used to weld the seams together. Because the seams are welded together, the barrier is preserved even if the panels contract in cold temperatures and expand in hot temperatures.

In one embodiment, the present invention is a method comprising: building a frame in an area; spraying an insulating foam composed of a first material onto the frame; shaping the foam; covering the shaped foam with a plurality of panels composed of a second material, thereby forming at least one seam between the plurality of panels; securing the plurality of panels to the frame; and welding together the at least one seam between the plurality of panels. The first material is polyurethane. The shaping includes: allowing the foam to harden; and cutting the hardened foam. The second material is polypropylene, which may be composed of homopolymer polypropylene or copolymer polypropylene. The method further includes securing a plate to an edge of at least one of the plurality of panels.

In another embodiment, the present invention is a method comprising: building a frame in an area; spraying an insulating foam composed of a first material onto the frame; cutting the foam; covering the cut foam with a plurality of panels composed of a second material, thereby forming at least one seam between the plurality of panels; securing the plurality of panels to the frame; and welding together the at least one seam between the plurality of panels. The first material is polyurethane. The second material is polypropylene which may be composed of homopolymer polypropylene or copolymer polypropylene. The method further includes securing a plate to an edge of at least one of the plurality of panels.

In a further embodiment, the present invention is a structure constructed by a method comprising: building a frame in an area; spraying an insulating foam composed of a first material onto the frame; shaping the foam; covering the shaped foam with a plurality of panels composed of a second material, thereby forming at least one seam between the plurality of panels; securing the plurality of panels to the frame; and welding together the at least one seam between the plurality of panels, thereby forming the structure. The first material is polyurethane. The shaping includes: allowing the foam to harden; and cutting the hardened foam. The second material is polypropylene which may be composed of homopolymer polypropylene or copolymer polypropylene. The structure further includes securing a plate to an edge of at least one of the plurality of panels.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 illustrates a flowchart of the method of the present invention;

FIG. 2 illustrates building a frame in an area;

FIG. 3 illustrates spraying polyurethane foam insulation onto the frame;

FIG. 4 illustrates cutting of the polyurethane foam insulation;

FIG. 5 illustrates covering the polyurethane foam with polypropylene panels;

FIG. 6 illustrates further covering the polyurethane foam with polypropylene panels;

FIG. 7 illustrates securing the polypropylene panels to the frame;

FIG. 8 illustrates welding together of seams between the polypropylene panels;

FIG. 9 illustrates a seam formed by the welding;

FIG. 10 illustrates securing plates to the edges;

FIG. 11 illustrates a close-up view of a plate secured to an edge; and

FIG. 12 illustrates implementation of the method to an interior compartment.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

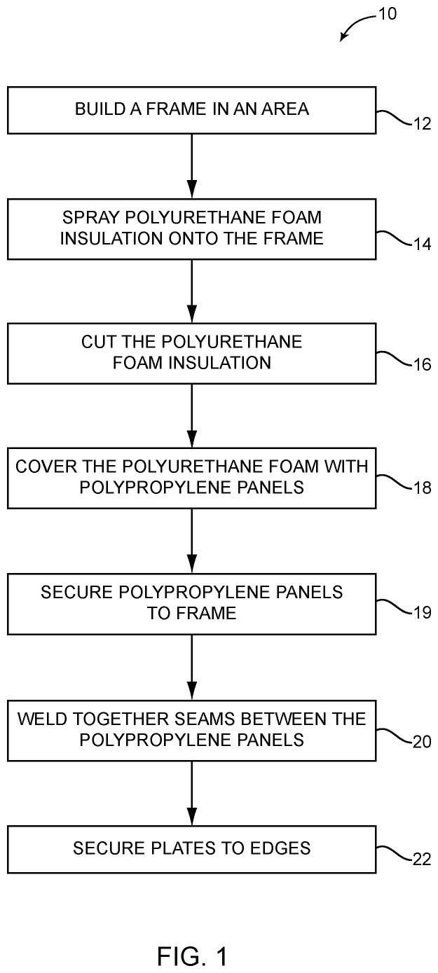

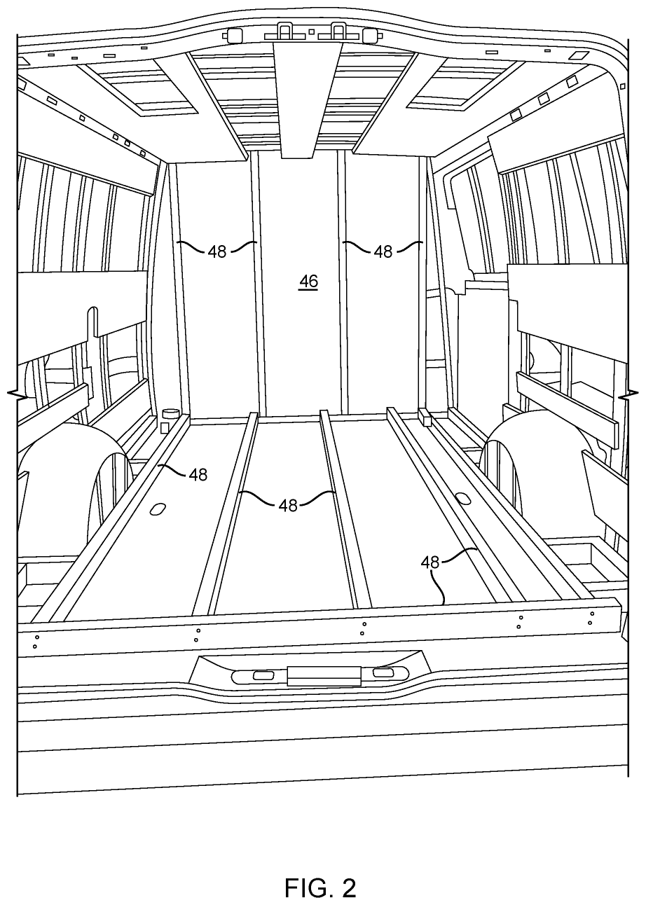

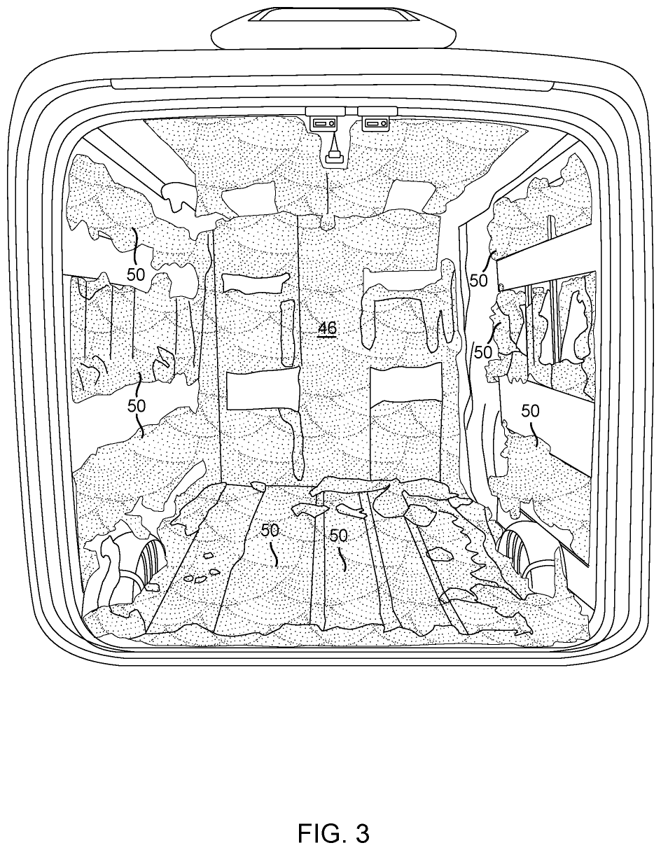

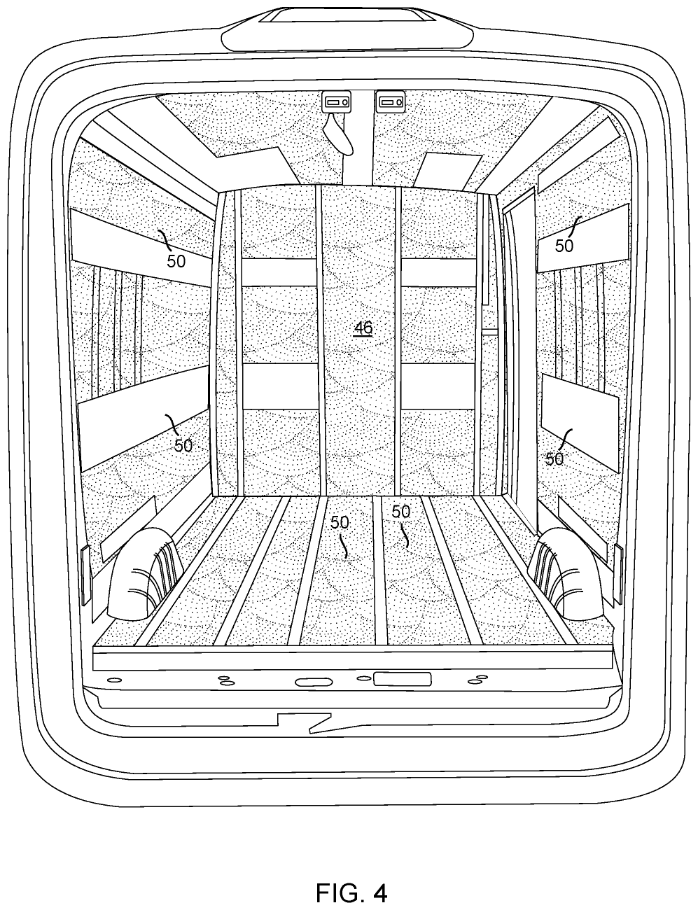

Using the method 10 of the present invention as shown in FIG. 1, a builder frames the inside area 46 of a vehicle or compartment using, for example, lumber 48 and nails in step 12, as shown in FIG. 2, then sprays closed-cell polyurethane insulating foam 50 throughout the walls, floors and ceiling of the thermo-insulated area 46 in step 14, as shown in FIG. 3. Once the foam 50 hardens to a degree that the foam 50 can be cut and/or shaped, the builder then cuts the insulating polyurethane foam 50 in step 16, as shown in FIG. 4. Cutting/shaping the insulating polyurethane foam 50 is performed to remove any excess insulation and to make a relatively smooth insulation layer.

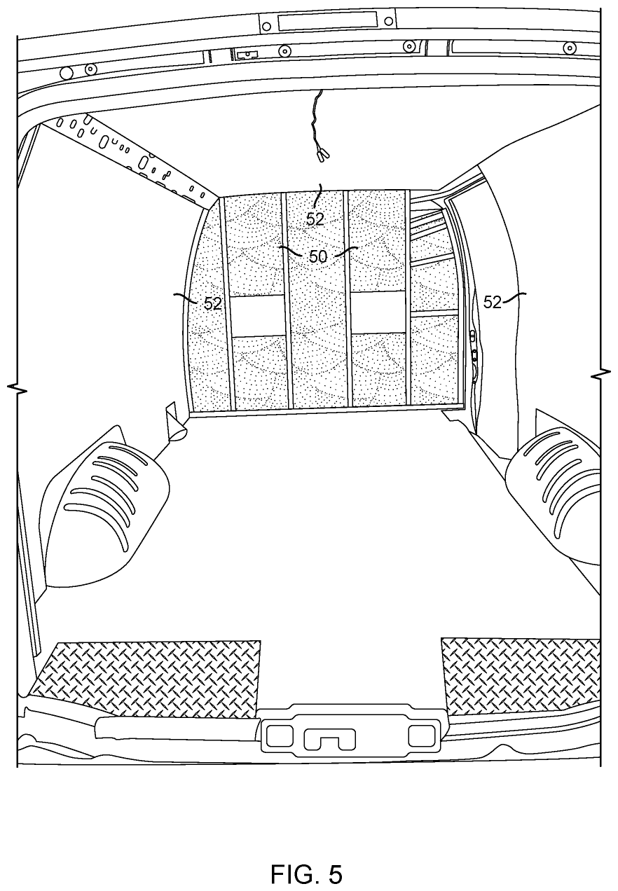

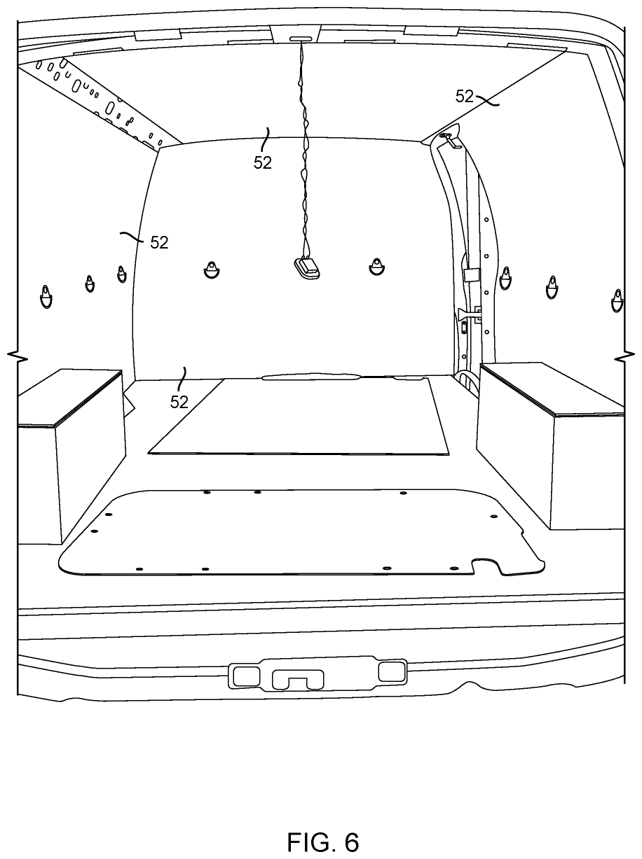

The builder then covers or encloses the cut/shaped insulating polyurethane foam 50 using panels 52 that are cut and shaped from polypropylene sheets, composed of either or both of homopolymer polypropylene and copolymer polypropylene versions, in step 18, as shown in FIGS. 5-6. Polypropylene is a versatile, lightweight thermoplastic with high strength, and chemical, moisture and corrosion resistance. Polypropylene is easily vacuum-formed, thermo-formed, fabricated, hot air welded and machined. Polypropylene is available in copolymer sheets, homopolymer sheets, copolymer rods, and homopolymer rods. The polypropylene sheets may be of any thickness, and may be composed of any type, blend, or derivative of polypropylene or copolymer polypropylene. The cut polypropylene sheets forms panels which may be substantially smooth.

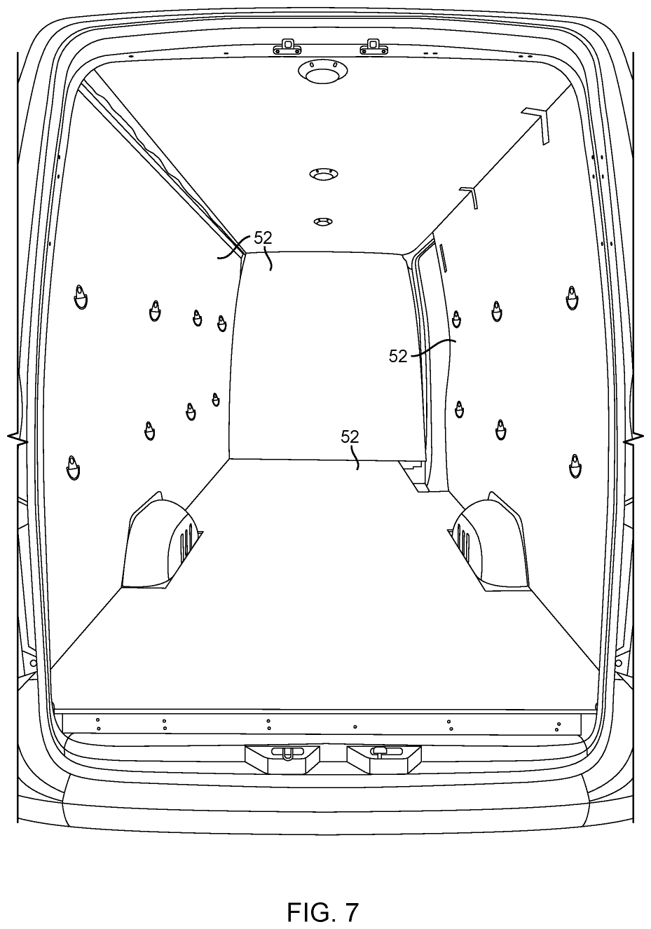

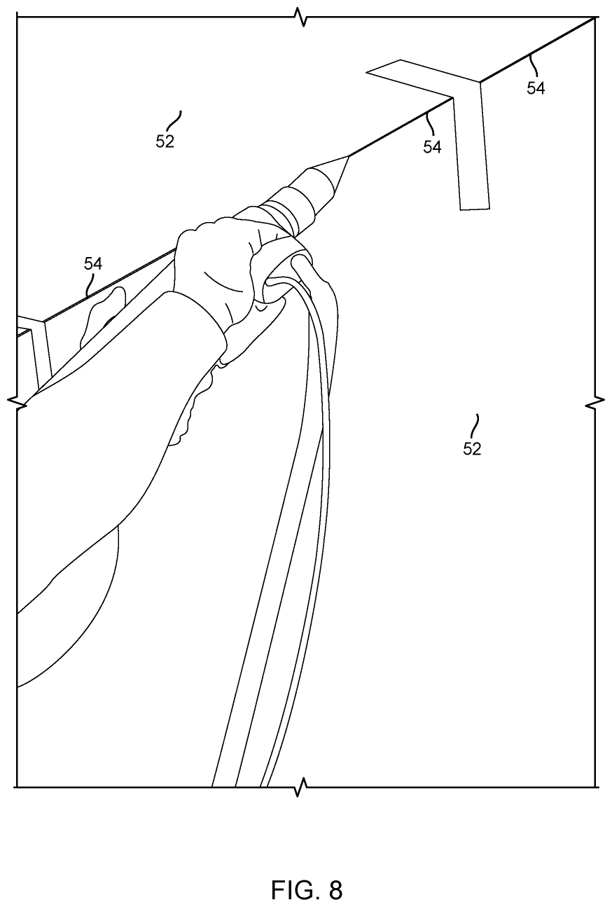

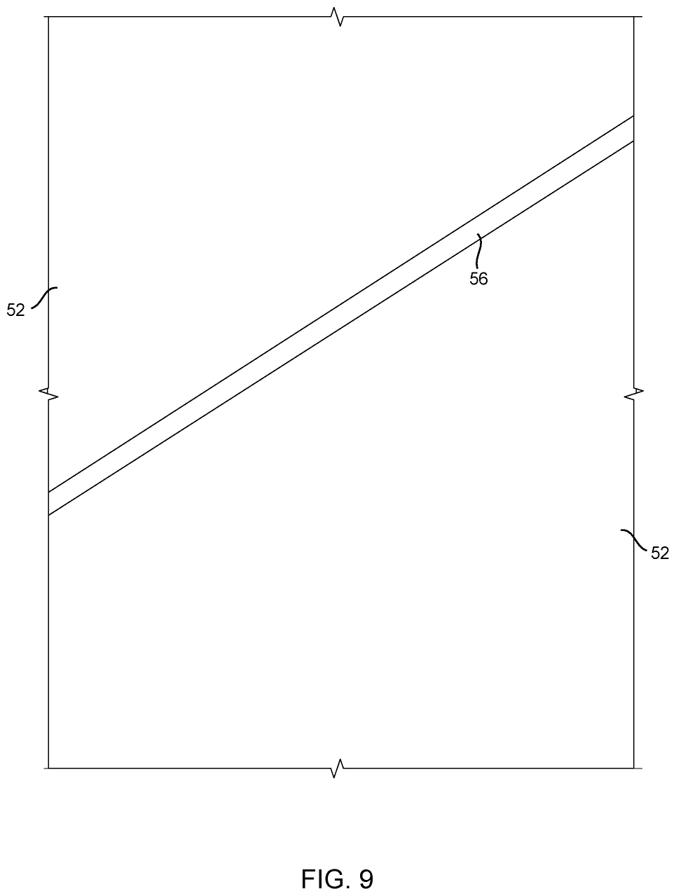

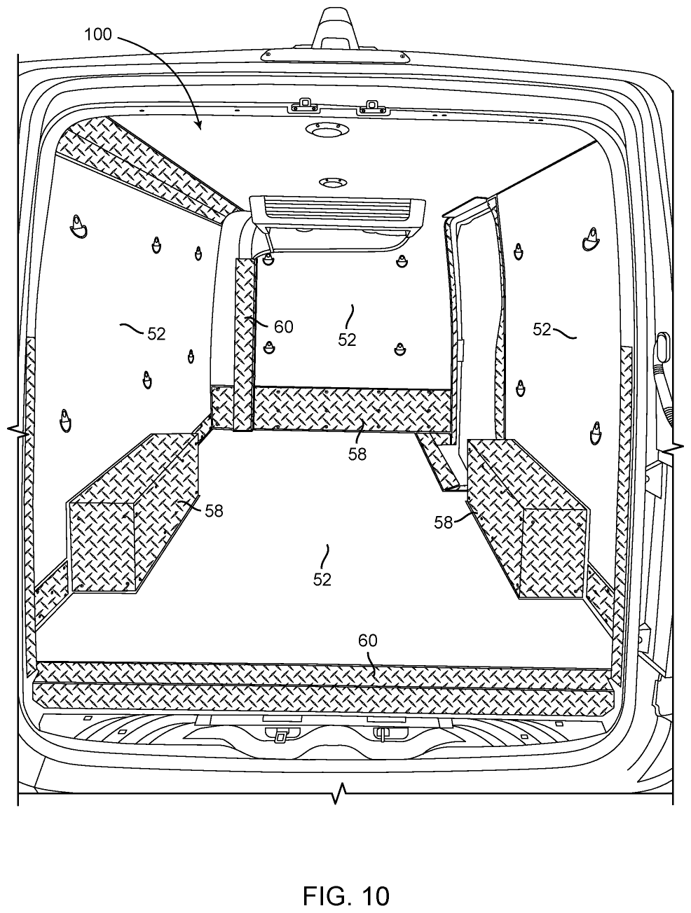

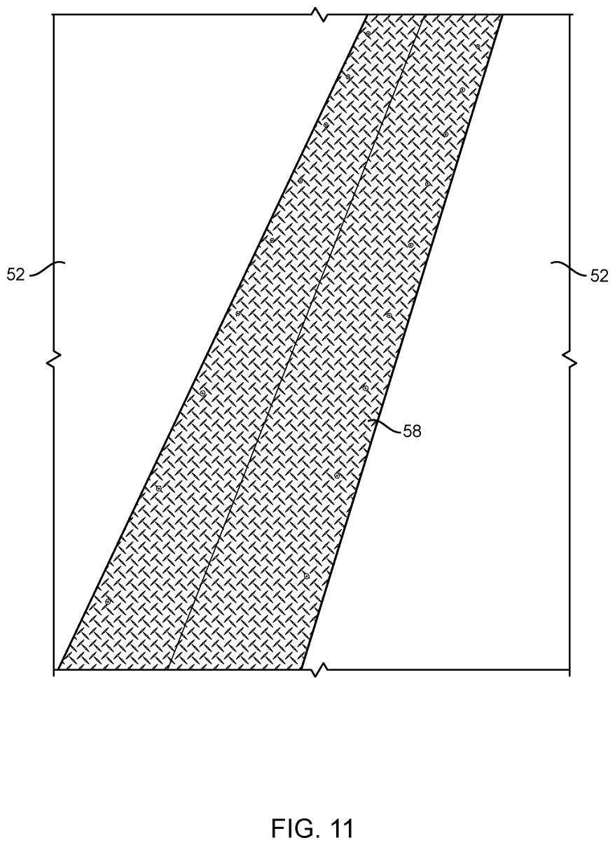

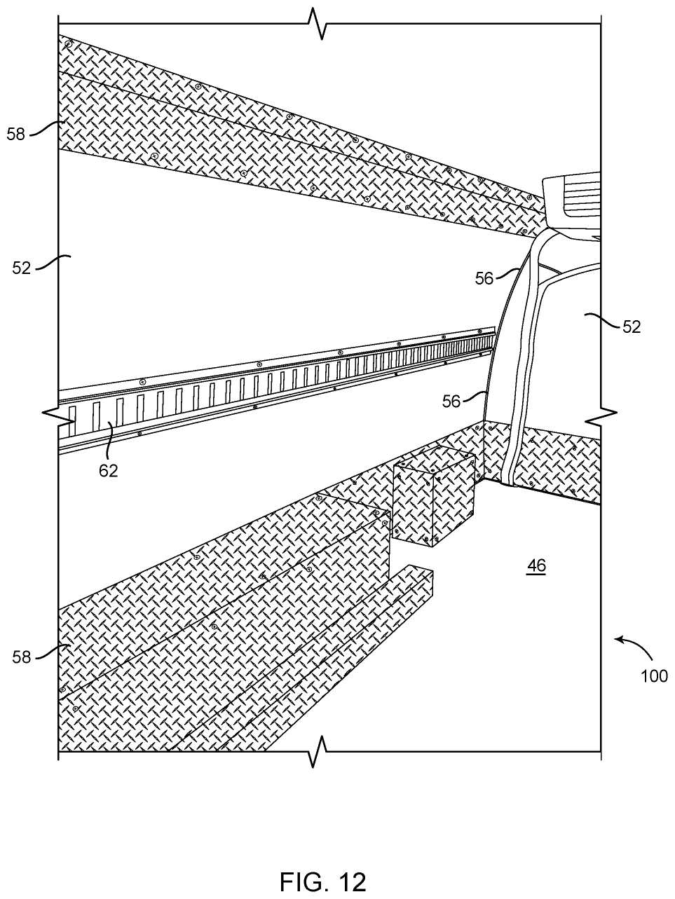

The present invention includes the use of polypropylene thermoplastic sheets in the process of creating thermo-insulated panels for installation inside thermo-insulated vehicles and compartments. Referring to FIG. 12, once the builder cuts, shapes, and attaches the polypropylene panels 52 to the interior 46 of the vehicle or compartment in step 18, as shown in FIGS. 5-6, the polypropylene panels 52 are secured to the underlying lumber 48 forming the frame in step 19, as shown in FIG. 7, by any known fasteners and/or adhesives, such as lag bolts and screws, as shown in step 19 in FIG. 1. Then, the seams 54 of the polypropylene panels 52 are welded together to form welded seams 56 in step 20, as shown in FIGS. 8-9, in order to seal any seams 54 that would allow water or other liquids to seep between the polypropylene panels 52 and into the insulated walls where any liquid would cause mold and other undesirable conditions. The welded seams 56 of the polypropylene panels 52 establish the structure 100, shown in FIG. 10, which provides a durable, flexible, and resilient container with relatively high water and chemical resistance. The welded seams 56 of the polypropylene panels 52 may optionally be covered with plates 58, 60 such as diamond plates, and metal strips 62, in step 22, as shown in FIGS. 10-11, to form the final structure 100.

There are two primary types of polypropylene thermoplastic sheets used in the present invention: homopolymer polypropylene and copolymer polypropylene (copoly). Polypropylene is used in a wide variety of applications including packaging and labeling, orthotics and prosthetics, laboratory equipment, chemical tanks and automotive components. Common applications for both homopolymer polypropylene and copolymer polypropylene include die cutting pads, fire truck water and foam tanks, plating and anodizing process equipment, fabricated parts/living hinge parts, orthotic and prosthetic devices, tanks, and secondary equipment. Polypropylene in general is used for packaging for consumer products, plastic parts for various industries, special devices such as living hinges, and textiles. Polypropylene is also used in meatpacking facilities as it meets USDA guidelines.

A first type of polypropylene is homopolymer polypropylene, which is a general-purpose grade of polypropylene. The primary characteristics of polypropylene thermoplastic sheets include the following:

(i) chemical resistance—diluted bases and acids do not react readily with polypropylene;

(ii) elasticity and toughness—polypropylene will act with elasticity over a certain range of deflection, but polypropylene is also generally considered a “tough” material, by which toughness is an engineering term which is defined as a material's ability to deform plastically, not elastically, without breaking;

(iii) fatigue resistance—polypropylene retains its shape after a significant amount of torsion, bending, and/or flexing;

(iv) opacity—although polypropylene can be made transparent, it is normally produced to be naturally opaque with one or more colors;

(v) thermoplasticity—polypropylene is classified as a thermoplastic material, as opposed to a thermoset-type material, which involves the way the plastic responds to heat. Thermoplastic materials soften and become liquid at their melting point, which is in the range of about 160° C. (about 320° F.) to about 170° C. (about 338° F.) in the case of copolymer polypropylene, while homopolymer polypropylene has a melting point of about 165° C. (about 329° F.). A combination of copolymer (copoly) polypropylene and homopolymer polypropylene may be used in the present invention as panels, so the panels having such a combination of polypropylene would soften and melt in the range of about 160° C. (about 320° F.) to about 170° C. (about 338° F.); and

(vi) safety—when polypropylene sheets are cut, the cutting creates shavings rather than dust, as is the case of cutting MDFs in the prior art, so the creation of shavings instead of dust is healthier and safer, and so is one of the benefits of the present invention.

In addition, a major useful attribute about thermoplastics is that they can be heated to their melting point, cooled, and reheated again without significant degradation. Instead of burning as in the case of thermoset materials in the prior art, thermoplastics such as polypropylene liquefy, which allows them to be easily injection molded and then subsequently recycled. By contrast, thermoset plastics can only be heated once, typically during the injection molding process. The first heating causes thermoset materials to set, in a manner similar to a two-part epoxy, resulting in a chemical change that cannot be reversed. If one tries to heat a thermoset plastic in the prior art to a high temperature a second time, the thermoset plastic would simply burn, preventing thermoset plastic panels from being welded to seal seams therebetween. This characteristic makes thermoset materials in the prior art poor candidates for use in the present invention.

A second type of polypropylene is a copolymer polypropylene, or copoly. Natural copolymer polypropylene, or copoly, is much like homopolymer polypropylene, but copoly has an ethylene additive which slightly increases flexibility and improves impact strength, especially at low temperatures. Copolymer polypropylene is used in many of the same applications as homopolymer polypropylene but where slightly more flexibility is needed. Copolymer polypropylene has a moderate rigidity, excellent formability and good stress crack resistance. Copolymer polypropylene provides outstanding toughness and performs well at temperatures as low as about −140° C. (about −220° F.). Other properties of copoly are a specific gravity of about 0.91, water absorption of less than about 0.01% after about 25 hours, a tensile strength of about 3500 psi at the time of yielding, a flexural modulus of about 155,000 psi, a continuous operating temperature of about 82.2° C. (about 180° F.), an Izod impact value under a notch of about 427 J/m (about 8.0 ft-lbs/in), and a Rockwell hardness value of M70/R118.

Both types of polypropylene, namely homopolymer polypropylene and copolymer (copoly) polypropylene, can be used as thermoplastic panels 52 in the present invention, as shown in FIGS. 1-12, and both types of polypropylene thermoplastic panels 52 can be welded in step 20 of FIG. 1 and shown in FIGS. 8-9 using one of two primary welding methods. For the first method, the welder uses a hot air welding/heating assembly that is temperature adjustable for welding plastics at various melting points. A plastic welder can form and bend plastic panels and rods, and melt plastic rods to form a welded seam 56 between copoly panels 52 as shown in FIGS. 8 and 12. The welder typically includes a stainless steel heating barrel and tip. For the second method, the welder uses an injection plastic welding apparatus with an automatic feed system. In such a welding apparatus, a welding rod is automatically drawn into an injection gun by a set of rod driver wheels and fed into a connecting tube where the welding rod is melted, and the melted welding rod is then applied to form the thermoplastic weld between the polypropylene panels. For example, a specific hand-operated injection plastic welder is known and commercially available as the DRADER INJECTIWELD™.

Referring to FIGS. 10 and 12, the structure 100 has the panels 52 which are substantially flush to form the walls, ceiling and floor of the compartment 46, and then all seams 54 are welded, as described in step 20 of FIG. 1, and shown in FIGS. 8-9. Wheel wells and entry points of the vehicle, in which the structure 100 is disposed, may then be covered with, for example, diamond plate metal 58, 60, as shown in FIGS. 10-11, as added protection against potential damage from loading equipment, pallets, etc. placed in the compartment 34. Diamond plates 58, 60 are optionally used along the ceiling to enable access to the vehicle's electrical harness. “E-track” metal strips 62 are optionally secured to the side walls to enable the user to use straps and tie-downs to secure cargo while the vehicle or compartment is in motion. Lag bolts are used to secure the E-track metal strips 62 along the side walls, and the lag bolts also serve the purpose of securing the polypropylene panels 52 to the side walls and, for larger vehicles and compartments, covering the welded seams 56 of the polypropylene panels 52 used on the side walls with diamond plate metal 58, 60, metal strips 62, or other elements, as shown in step 22 of FIG. 1, to form the structure 100 shown in FIGS. 10 and 12. Stainless steel screws used to affix the diamond plate metal 58, 60 also serve the purpose of securing the polypropylene panels 52 to the floor, side walls, ceiling and internal wood framing. The use of screws and lag bolts does not affect the integrity of the structure or the insulation properties. Alternatively, the various metal plates, screws, and lag bolts may be omitted or not needed on all vehicles or compartments 34, and are considered to be useful, but not essential to the present invention.

In addition, a specific type of adhesive may be used in the compartment that has properties that are beneficial for bonding to low surface-energy plastics, such as the polypropylene panel 52 used in the present invention. Such an adhesive can be useful in place of screws and lag bolts, and also can be useful for other specific applications such as to create drain holes in the copoly floor. For example, a specific adhesive is known and commercially available as LOCTITE 3035.

In alternative embodiments, the present invention includes the use of different types and thicknesses of polypropylene sheets as the primary material for use in the creation of the panels 52 in FIG. 12. For example, the present invention may also use colored sheets with any degree of opacity that ensures that the user cannot see through the panel 52.

The present invention recognizes that it is novel and unique to use polypropylene sheets in the production of thermo-insulated panels 52 as components of a structure 100 inside vehicles and other compartments, and that it is novel and unique to weld polypropylene sheets and panels 52 together at seams 54, as in FIGS. 8-10 and 12, in order to form a structure 100 with seamless thermo-insulated panels inside vehicles and other compartments.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A method comprising:
building a frame in an area;
spraying an insulating foam composed of a first material onto the frame;
shaping the foam;
covering the shaped foam with a plurality of panels composed of a second material, thereby forming at least one seam between the plurality of panels;
securing the plurality of panels to the frame; and
welding together the at least one seam between the plurality of panels.

2. The method of claim 1, wherein the first material is polyurethane.

3. The method of claim 1, wherein the shaping includes:
allowing the foam to harden; and
cutting the hardened foam.

4. The method of claim 1, wherein the second material is polypropylene.

5. The method of claim 4, wherein the polypropylene is composed of homopolymer polypropylene.

6. The method of claim 4, wherein the polypropylene is composed of copolymer polypropylene.

7. The method of claim 1, further comprising:
securing a plate to an edge of at least one of the plurality of panels.

8. A method comprising:
building a frame in an area;
spraying an insulating foam composed of a first material onto the frame;
cutting the foam;
covering the cut foam with a plurality of panels composed of a second material, thereby forming at least one seam between the plurality of panels;
securing the plurality of panels to the frame; and
welding together the at least one seam between the plurality of panels.

9. The method of claim 8, wherein the first material is polyurethane.

10. The method of claim 8, wherein the second material is polypropylene.

11. The method of claim 10, wherein the polypropylene is composed of homopolymer polypropylene.

12. The method of claim 10, wherein the polypropylene is composed of copolymer polypropylene.

13. The method of claim 8, further comprising:
securing a plate to an edge of at least one of the plurality of panels.

14. A structure constructed by a method comprising:
building a frame in an area;
spraying an insulating foam composed of a first material onto the frame;
shaping the foam;
covering the shaped foam with a plurality of panels composed of a second material, thereby forming at least one seam between the plurality of panels;
securing the plurality of panels to the frame; and
welding together the at least one seam between the plurality of panels, thereby forming the structure.

15. The structure of claim 14, wherein the first material is polyurethane.

16. The structure of claim 14, wherein the shaping includes:
allowing the foam to harden; and
cutting the hardened foam.

17. The structure of claim 14, wherein the second material is polypropylene.

18. The structure of claim 17, wherein the polypropylene is composed of homopolymer polypropylene.

19. The structure of claim 17, wherein the polypropylene is composed of copolymer polypropylene.

20. The structure of claim 14, further comprising:
securing a plate to an edge of at least one of the plurality of panels.
